(19) United States
(12) Patent Application Publication
(10) Pub. No.: US 2019/0337790 A1
(43) Pub. Date: Nov. 7, 2019

(54) AUTOMATIC WATER FILL DISPENSER FOR REFRIGERATOR

(71) Applicant: Daewoo Electronics Co., Ltd., Gwangju (KR)

(72) Inventor: Wang-Koo LEE, Incheon (KR)

(21) Appl. No.: 16/233,994

(22) Filed: Dec. 27, 2018

(30) Foreign Application Priority Data
May 2, 2018 (KR) 10-2018-0050792

(51) Int. Cl. B67D 3/00; F25D 23/12

(52) U.S. Cl. CPC B67D 3/0003; F25D 23/126; F25D 2331/806; F25C 2700/04; F25D 2323/122; B67D 3/0009

(57) ABSTRACT

Embodiments of the present invention relate generally to an automatic water fill dispenser for a refrigerator appliance. More particularly, the embodiments of the present invention relate to an automatic water fill dispenser for a refrigerator, in which the dispenser includes a storage unit configured to store water inside the refrigerator door, and a container unit configured to be automatically supplied with water from the storage unit. The automatic water fill dispenser includes: a storage unit provided in an inner side surface of a refrigerator door and configured to store water; and a container unit provided on a side of the storage unit in fluid communication with the storage unit and configured to receive water automatically from the storage unit.

### CROSS REFERENCE TO RELATED APPLICATION

The present application claims priority to Korean Patent Application No. 10-2018-0050792, filed May 2, 2018, the entire contents of which is incorporated herein for all purposes by this reference.

### BACKGROUND OF THE INVENTION

### Field of the Invention

Embodiments of the present invention relate generally to an automatic water fill dispenser for a refrigerator appliance. More particularly, embodiments of the present invention also relate to a refrigerator appliance having such an automatic fill dispenser.

### Description of the Related Art

A refrigerator, is an appliance that maintains various kinds of food items stored inside and fresh. The appliance typicallyhas a freezing chamber that is maintained at subzero temperatures to freeze and store the food items, and a refrigerating chamber that is maintained at temperatures lower than room temperature so as to maintain food freshness without freezing. Since the introduction of home refrigerator appliances in the 1900s, much research and development have been continuously conducted for improving food storage and user convenience.

As part of this development, a refrigerator may be provided with a water supply system so that users can dispense drinking water from the refrigerator. For example, in the document of Korean Patent No. 10-0430217, there is disclosed a drinking water dispenser that allows a user to dispense water outside of the refrigerator.

In the case of a drinking water dispenser that is provided outside the refrigerator, the drinking water can be supplied without the user opening the refrigerator door, but there is a disadvantage in that this design limits the degrees of freedom available in designing the exterior of the refrigerator. Further, a large space or volume is required to automatically store/supply a large amount of cold water, which thereby increases manufacturing costs of the appliance. In addition, if the outer material of the refrigerator door is made of glass, it is required to provide a port or hole located where the dispenser is disposed to allow access thereto. The provision of such a port is a difficult task in glass and therefore increases the manufacturing costs of the appliance.

Therefore, it is advantageous to provide an automatic water fill dispenser for a refrigerator appliance which can automatically supply a large amount of cold water more efficiently with better user convenience.

The foregoing is intended merely to aid in the understanding of the background of the present invention, and is not intended to mean that the present invention falls within the purview of the related art that is already known to those skilled in the art.

### SUMMARY OF THE INVENTION

Accordingly, embodiments of the present invention have been made considering the above problems occurring in the related art, and it is an object of the present invention to provide an automatic water fill dispenser that is provided inside the refrigerator.

Further, it is another object of the present invention to provide an automatic water fill dispenser for a refrigerator appliance, in which the automatic water fill dispenser design provides increased flexibility allowed in the design and production of the refrigerator exterior and also in helping to provide a clean appearance thereof.

Further, it is a further object of the present invention to provide an automatic water fill dispenser for a refrigerator that is capable of providing large amounts of cold water while maintaining a low manufacturing cost.

Further, it is still a further object of the present invention to provide an automatic water fill dispenser for a refrigerator, in which water is automatically supplied to the dispenser.

It is to be understood that the objects of the present invention are not limited to the above-mentioned objects, and other objects not mentioned can be understood by one of ordinary skill in the art to which this invention belongs (hereinafter, referred to as those skilled in the art) from the following description.

In order to accomplish the objects of the present invention as described above and to carry out the characteristic functions of the present invention described below, features of the present invention are as follows.

According to an embodiment of the present invention, an automatic water fill dispenser for a refrigerator includes: a storage unit provided in an inner side surface of a refrigerator door and configured to store water; and a container unit provided on a side of the storage unit in fluid communication with the storage unit and configured to automatically receive water from the storage unit.

Preferably, the automatic water fill dispenser further includes a water level sensor disposed on a rear side of the container unit and configured to detect the water level inside the container unit, wherein water is automatically supplied to the container unit by detection by the water level sensor.

Preferably, the automatic water fill dispenser further includes a water supply unit disposed between the storage unit and the container unit and configured to supply water from the storage unit to the container unit.

Preferably, the water supply unit includes: a water supply hose configured to be in fluid communication with the storage unit and the container unit; and a valve configured to regulate water flow through the water supply hose.

Preferably, the automatic water fill dispenser further includes a water level sensor disposed on a rear side of the container unit and configured to detect the water level inside the container unit, wherein the valve is configured to be selectively opened and closed by detection by the water level sensor.

Preferably, the container unit is mounted to a receiving unit disposed inside the refrigerator door.

Preferably, the container unit includes a lower concave portion recessed toward a surface side on a lower surface thereof, and the receiving unit includes a protruding rod that protrudes from a surface thereof, and vertically moveable, and engageable with the lower concave portion.

According to an embodiment of the present invention, an automatic water fill dispenser for a refrigerator appliance includes: a storage unit disposed in an inner side surface of a refrigerator door and configured to store water; a container unit disposed on a side of the storage unit in fluid communication with the storage unit and configured to automatically receive water from the storage unit; and a water supply unit disposed between the storage unit and the container unit to supply water from the storage unit to the container unit.

Preferably, the storage unit includes: a hole formed in a lower surface of the storage unit; a sealing member mounted in the hole; a pin coupled to the sealing member and configured to protrude from the sealing member; and a spring member mounted to an outer surface of the pin protruding from the sealing member, and further where the water supply unit includes a water receiving portion having an inner space defined by a protruding portion protruding from a surface thereof.

Preferably, the hole includes: a multi-perforated surface; and a partition member configured to partition the multi-perforated surface.

Preferably, the water supply unit is configured such that a lower surface thereof is provided with a coupling rod that protrudes therefrom and is vertically moveable, and an upper surface thereof is provided with an upper concave portion that is recessed toward a surface side to be engageable with the coupling rod.

According to an embodiment of the present invention, an automatic water fill dispenser for a refrigerator appliance includes: a storage unit disposed in an inner side surface of a refrigerator door and configured to store water; a container unit disposed on a side of the storage unit in fluid communication with the storage unit and configured to receive water automatically supplied from the storage unit; and a water supply unit disposed between the storage unit and the container unit and configured to supply water from the storage unit to the container unit, further wherein the storage unit includes a hole formed in a lower surface thereof, and a protruding portion that protrudes from the lower surface thereof to surround the hole, and where the water supply unit includes a coupling portion that protrudes from an upper surface thereof and is engageable with the protruding portion, and a through-hole disposed inside the coupling portion.

Preferably, a water supply hose is mounted in the through-hole, and a valve is connected with the water supply hose to regulate the flow of water through the water supply hose.

Preferably, the automatic water fill dispenser further includes a water level sensor disposed on a rear side of the container unit and configured to detect the water level inside the container unit, wherein the valve is configured to be selectively opened and closed by water level detection by the water level sensor.

According to embodiments of the present invention, there is provided an automatic water fill dispenser disposed inside the refrigerator.

Further, according to embodiments of the present invention, there is provided an automatic water fill dispenser for a refrigerator appliance, in which the automatic water fill dispenser is capable of improving the design flexibility in designing the exterior of the refrigerator and also providing a clean appearance thereof.

Further, according to embodiments of the present invention, there is provided an automatic water fill dispenser for a refrigerator, in which the automatic water fill dispenser is capable of providing a large volume of cold water while maintaining a low manufacturing cost.

Further, according to the embodiments of the present invention, there is provided an automatic water fill dispenser for a refrigerator, in which water is automatically supplied to the dispenser.

The effects of the present invention are not limited to those described above, and other effects not mentioned may be clearly understood by those skilled in the art from the following description.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a view showing a state in which an automatic water fill dispenser for a refrigerator appliance according to an embodiment of the present invention is provided in an inner side surface of a refrigerator door;

FIG. 2 is a view showing the automatic water fill dispenser according to an embodiment of the present invention;

FIG. 3 is an exploded view showing the automatic water fill dispenser according to an embodiment of the present invention;

FIG. 4A is a perspective view showing a lower lid of a storage unit according to an embodiment of the present invention;

FIG. 4B is a top view of FIG. 4A;

FIG. 4C is a bottom view of FIG. 4A;

FIG. 4D is a sectional view of FIG. 4A;

FIG. 5A is a perspective view showing a water supply unit according to an embodiment of the present invention;

FIG. 5B is a bottom cross-sectional view of FIG. 5A;

FIG. 5C is a view showing a state where the storage unit and the water supply unit are coupled to each other according to an embodiment of the present invention;

FIG. 5D is a bottom view of FIG. 5A;

FIG. 6 is a view showing a mounted state of the automatic water fill dispenser for a refrigerator appliance according to an embodiment of the present invention with the refrigerator door removed;

FIG. 7 is a view showing a mounted state of the automatic water fill dispenser for a refrigerator appliance according to an embodiment of the present invention;

FIGS. 8A and 8B are partial enlarged views of FIG. 7;

FIG. 9A is a bottom view showing a lid of a container unit according to an embodiment of the present invention;

FIG. 9B is a view showing a state where a tea cup is being mounted to a lower surface of the lid of the container unit according to an embodiment of the present invention container unit; and

FIG. 9C is a view showing a state where the tea cup has been mounted to the lower surface of the lid of the container unit according to an embodiment of the present invention container unit.

### DETAILED DESCRIPTION OF THE INVENTION

Specific structural or functional descriptions in the embodiments of the present invention disclosed in the specification or application are only for description of the embodiments of the present invention. The descriptions can be embodied in various forms and should not be construed as being limited to the embodiments described in the specification or application. Further, the present invention may be embodied in many different forms without departing from the spirit and significant characteristics of the invention. Therefore, the embodiments of the present invention are disclosed only for illustrative purposes and should not be construed as limiting the present invention.

Meanwhile, it will be understood that, although the terms first, second, etc. may be used herein to describe various elements, these elements should not be limited by these terms. These terms are only used to distinguish one element, from another element. For instance, a first element discussed below could be termed a second element without departing from the teachings of the present invention. Similarly, the second element could also be termed the first element.

It will be understood that when an element is referred to as being “coupled” or “connected” to another element, it can be directly coupled or connected to the other element or intervening elements may be present therebetween. In contrast, it should be understood that when an element is referred to as being “directly coupled” or “directly connected” to another element, there are no intervening elements present. Other expressions that explain the relationship between elements, such as “between”, “directly between”, “adjacent to”, or “directly adjacent to”, should be construed in the same way.

The same reference numerals will be used throughout the drawings and the description to refer to the same or like parts. Meanwhile, the terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprise”, “include”, “have”, etc. when used in this specification, specify the presence of stated features, integers, steps, operations, elements, components, and/or combinations thereof but do not preclude the presence or addition of one or more other features, integers, steps, operations, elements, components, and/or combinations thereof.

An automatic water fill dispenser for a refrigerator appliance according to an embodiment of the present invention includes: a storage unit disposed in an inner side surface of a refrigerator door and configured to store water; and a container unit disposed on a side of the storage unit in fluid communication with the storage unit and configured to automatically receive water from the storage unit.

Hereinbelow, an exemplary embodiment of the present invention will be described in detail with reference to the accompanying drawings.

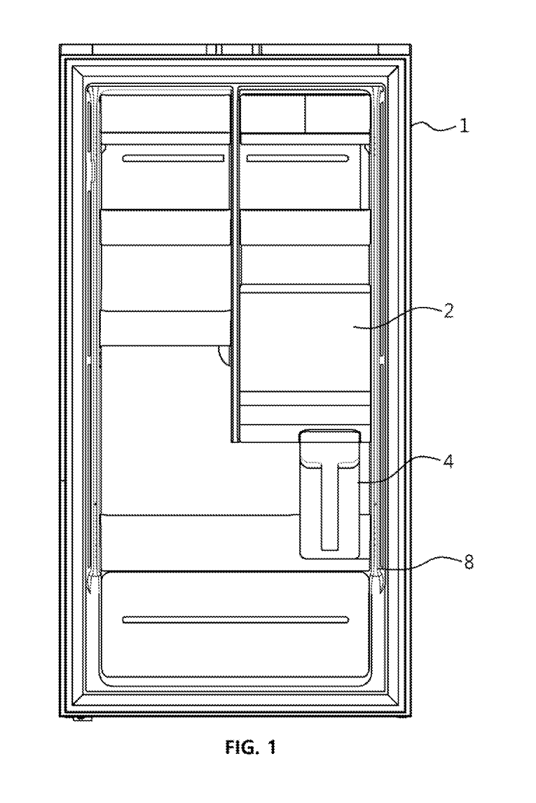

As shown in FIG. 1, an automatic water fill dispenser for a refrigerator appliance according to an embodiment of the present invention includes: a storage unit 2 configured to store water; and a container unit 4 disposed on a side of the storage unit 2 in fluid communication with the storage unit 2 and configured to automatically receive water from the storage unit 2. The storage unit 2 and the container unit 4 are mounted to an inner side surface of a refrigerator door 1. According to an embodiment of the present invention, unlike a conventional water dispenser disposed on the outer surface of the refrigerator door, where the water dispenser is disposed on the inner side surface thereof, thereby improving the flexibility allowed in designing the exterior of the refrigerator and further reducing the manufacturing costs thereof.

Preferably, the storage unit 2 is disposed at an upper portion of the container unit 4, and the container unit 4 is supported by a support unit 8. The support unit 8 may be a receiving unit 18 of multiple receiving units provided on the inner side of the refrigerator door 1, and may be mounted to a mount 28 provided in the receiving unit 18 and shaped corresponding to the shape of the container unit 4.

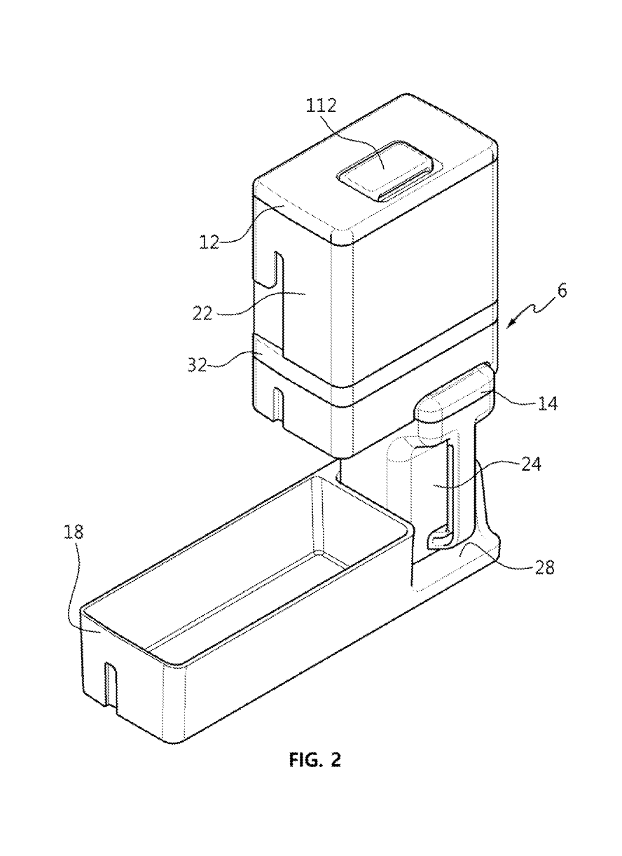

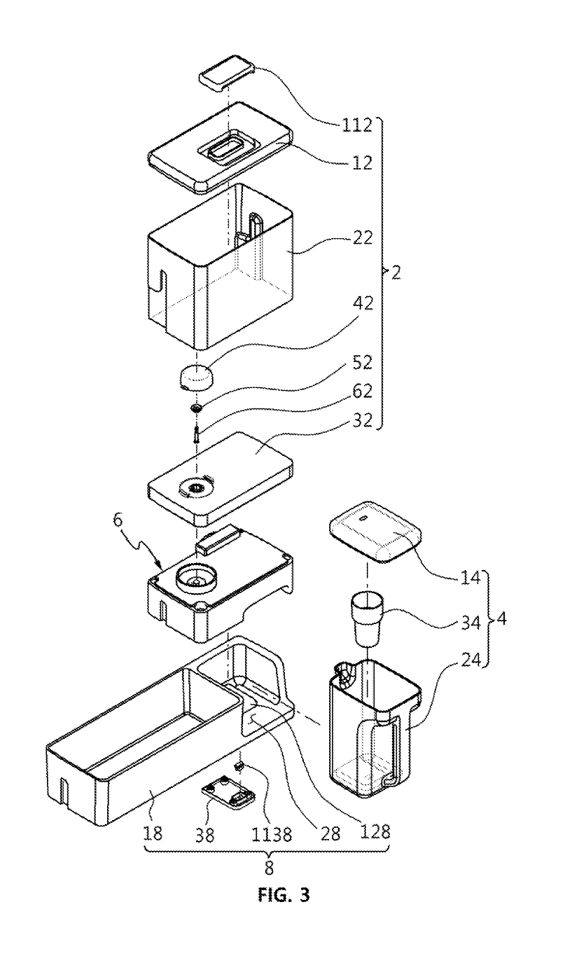

Referring to FIGS. 2 and 3, the storage unit 2 (where water is stored) may include an upper lid 12, a tank 22, and a lower lid 32. The upper lid 12 corresponds to the upper structure of the storage unit 2, and the upper lid 12 may be formed with a supply portion 112 for supplying water to the storage unit 2. The tank 22 allows detection of the water level therein and corresponds to the side structure of the storage unit 2. The lower lid 32 corresponds to the lower structure of the storage unit 2. The lower lid 32 includes an opening through which water from the storage unit 2 can be drained.

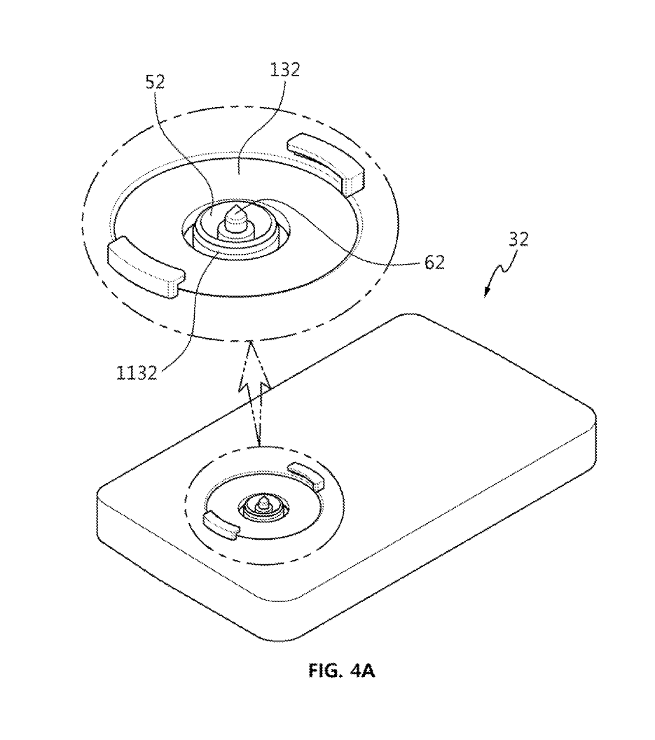

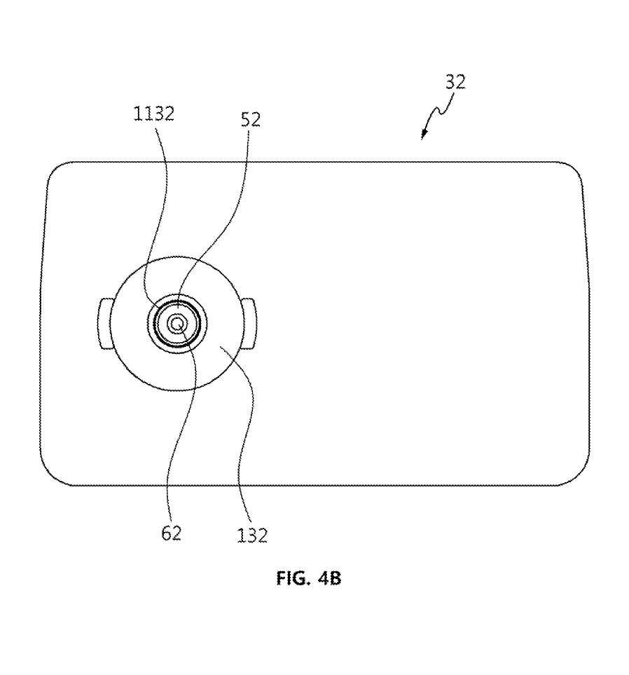

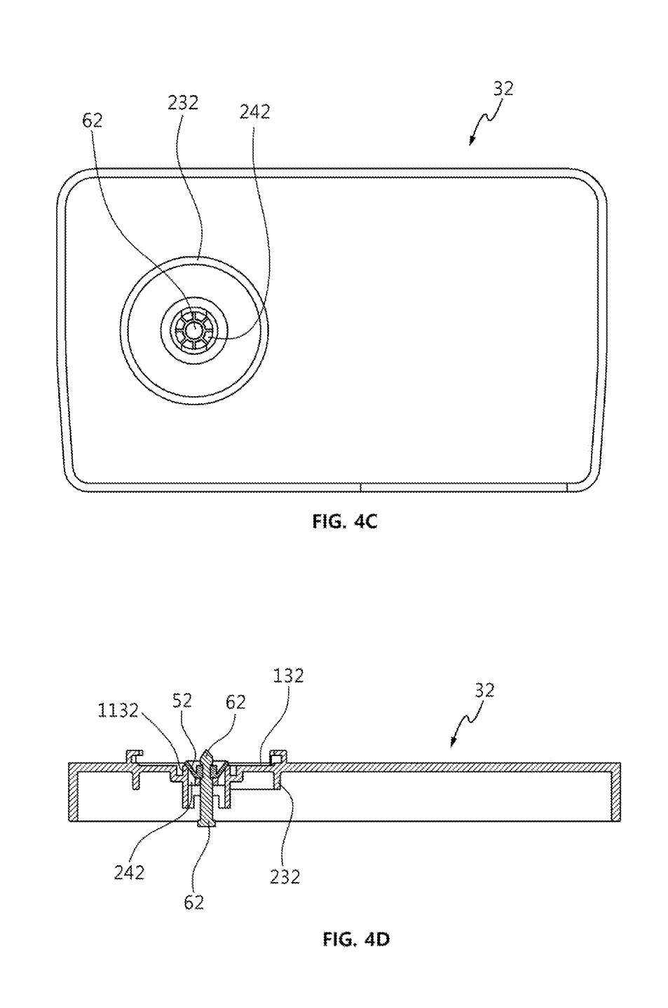

The lower lid 32, according to an embodiment of the present invention, will be described with reference to FIGS. 4A to 4D. At the upper surface of the lower lid 32, a cap 42 having a slit with the water in the tank 22 passing therethrough may be mounted. Further, a recessed portion 132 may be formed on the upper surface of the lower lid 32 to allow the cap 42 to be inserted therein. A hole 1132 is formed in the center of the recessed portion 132 so that water in the tank 22 can be discharged through the hole 1132.

According to embodiments of the present invention, a sealing member 52, a pin 62, and a spring member 72 are disposed at the hole 1132 so that when the storage unit 2 is removed for cleaning, water is prevented from flowing out and thus it is possible to easily mount and dismount the storage unit 2. The sealing member 52 is inserted in the hole 1132, and the pin 62 is coupled to the center of the sealing member 52. The pin 62 is mounted to the lower surface of the lower lid 32 and configured to protrude therefrom. The spring member 72 is mounted to an outer surface of the protruding pin 62. The sealing member 52 and the pin 62 are configured to be moved together under pressure. When the storage unit 2 is mounted, the pin 62 is pressed and the sealing member 52 is separated from the hole 1132, whereby water is discharged through a gap defined by the sealing member 52 and the hole 1132. When the storage unit 2 is dismounted and the pressure applied to the pin 62 is removed, the spring member 72 is restored and the sealing member 52 is seated in the hole 1132 to prevent water from being discharged. As shown in FIG. 4C, the hole 1132 may include a multi-perforated surface 242 partitioned by a partition member.

The lower surface of the lower lid 32 may be formed with a protruding portion 232 protruding therefrom. The protruding portion 232 may form a space for receiving water by being coupled with a frame 16 of water supply unit 6 to be described below.

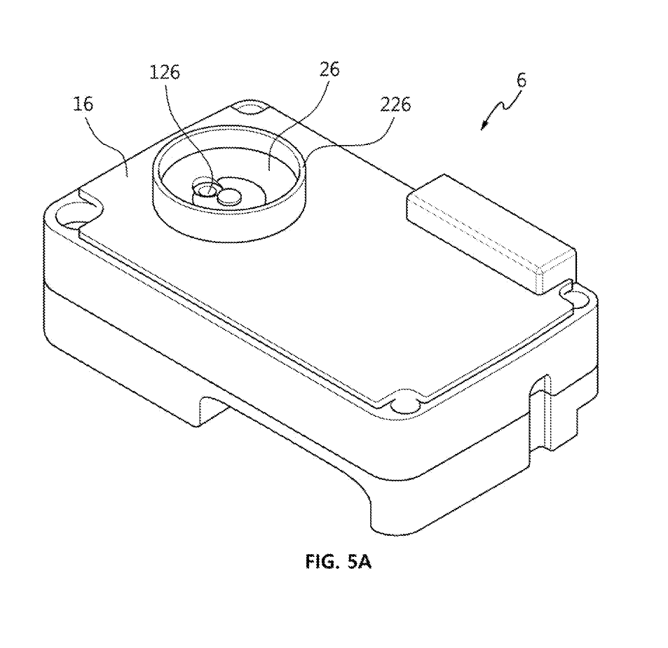

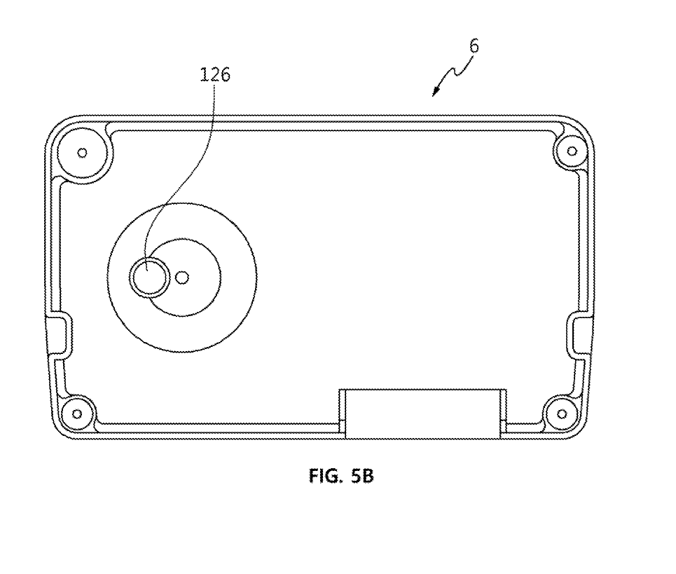

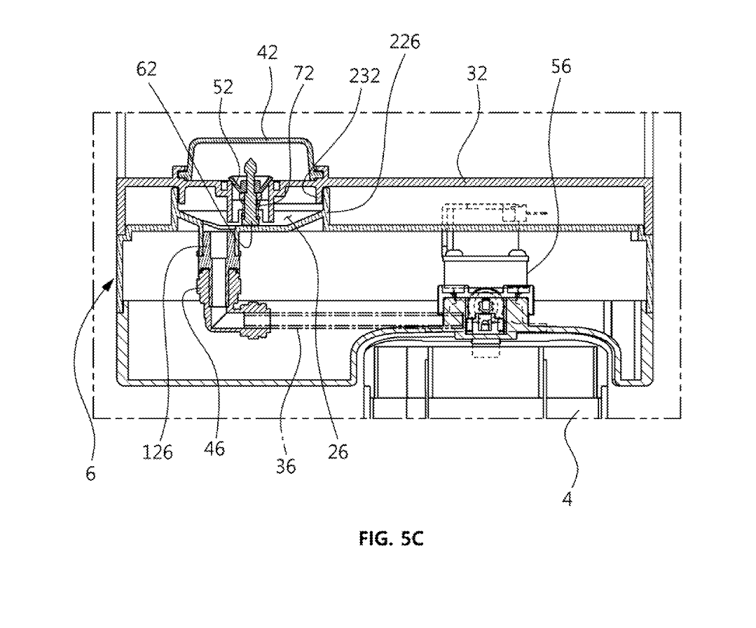

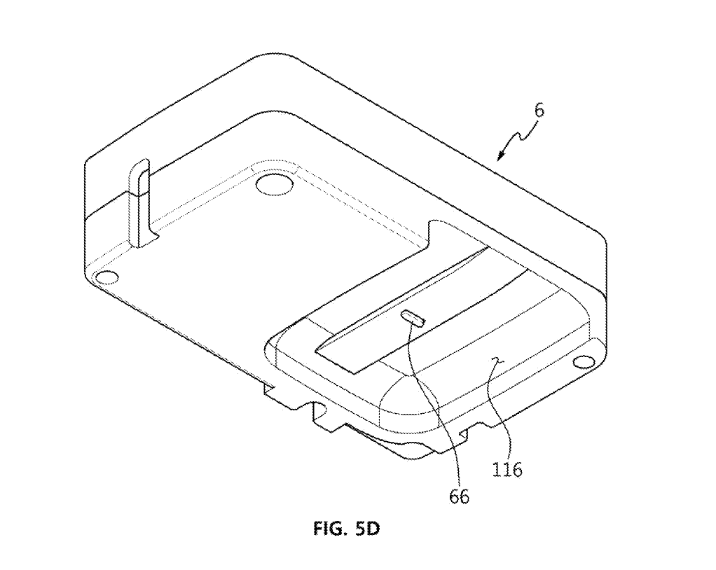

The water supply unit 6 delivers water from the storage unit 2 to the container unit 4. Referring to FIGS. 5A to 5C, the water supply unit 6 according to an embodiment of the present invention will be described as follows. The water supply unit 6 may include the frame 16, wherein the lower lid 32 is coupled to an upper surface of the frame 16. The protruding portion 232 of the lower lid 32 may be fitted in a coupling portion 226 protruding from an upper surface of the frame 16. The protruding portion 232 and the coupling portion 226 are fitted together to form a water receiving portion 26. In the water receiving portion 26, a through-hole 126 is formed such that a water supply hose 36 is mounted to a lower portion thereof. As shown in FIG. 5C, the pin 62 is pressed by the surface of the frame 16 to allow water to flow. The water contained in the water receiving portion 26 flows into an inlet 224 of the container unit 4 via the water supply hose 36 and a water supply joint 46.

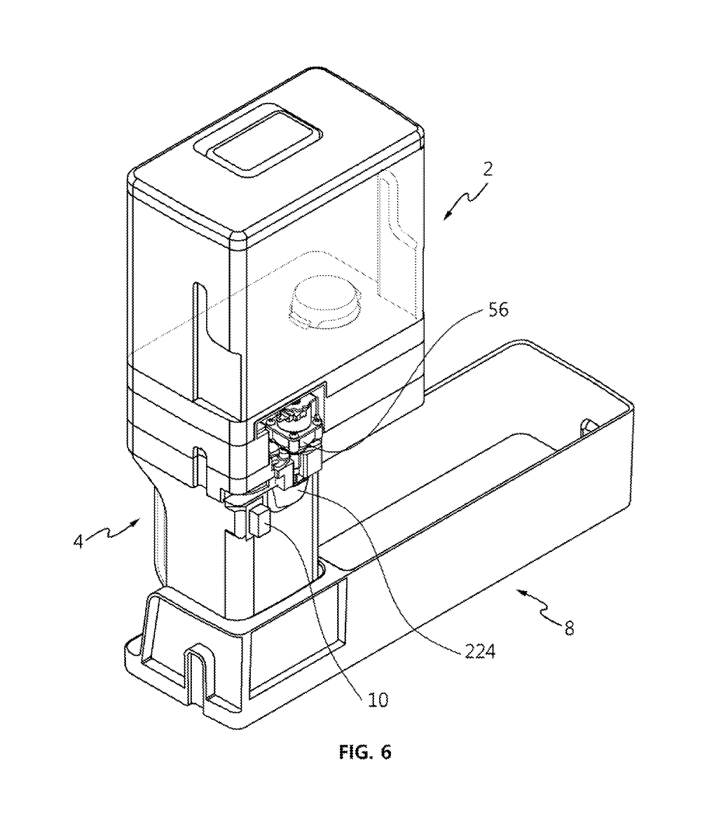

According to an embodiment of the present invention, as shown in FIG. 6, the automatic water fill dispenser may further include: a water level sensor 10; and a valve 56 configured to control water supply. The water level sensor 10 is mounted either at the inner side surface of the refrigerator door 1, or at the rear side of the container unit 4. According to embodiments of the present invention, the water level sensor 10 is configured to detect the water level in the container unit 4, and to transmit the same to a micom actuator (not shown) to control the opening and closing of the valve 56. Preferably, the water level sensor may be a non-contact capacitive type sensor for hygienic considerations.

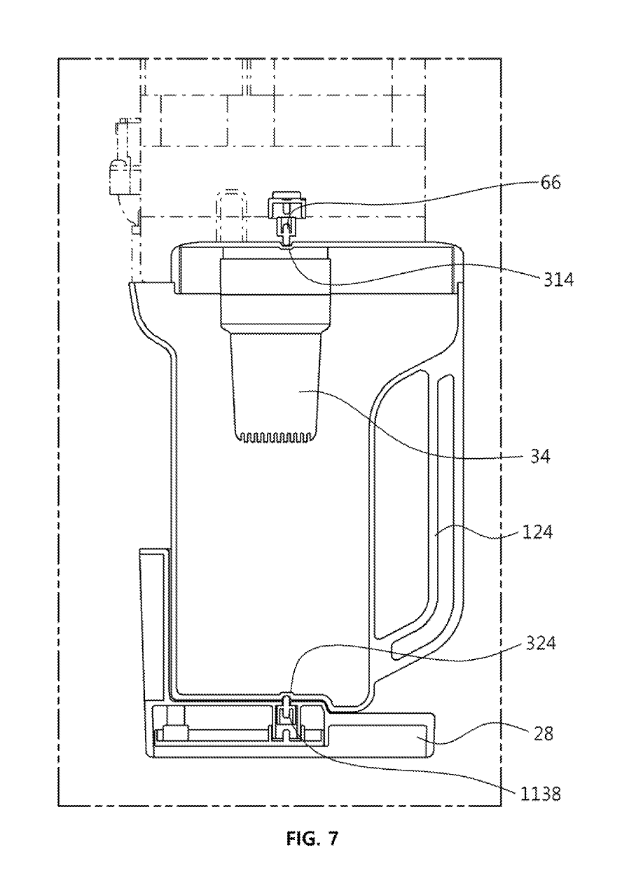

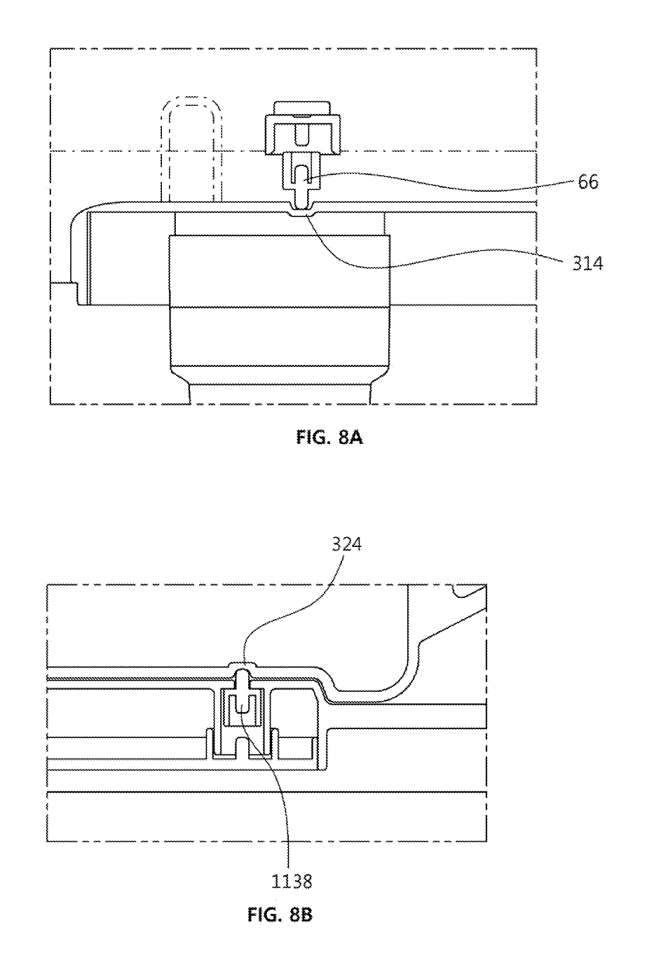

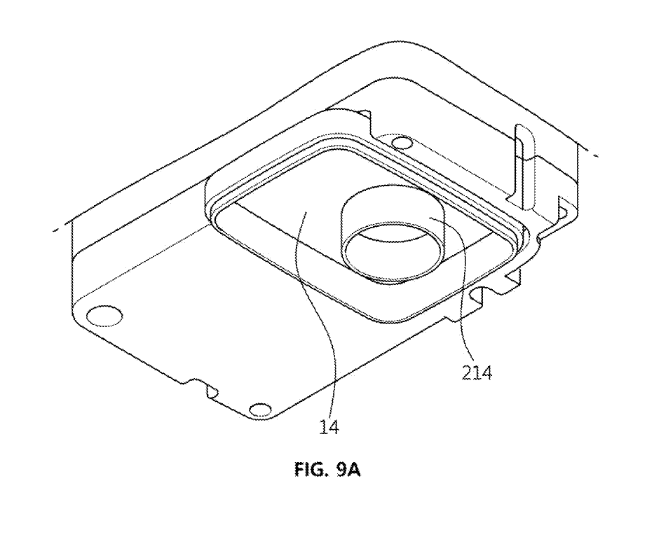

Referring to FIGS. 7 and 8A, the container unit 4 is mounted to the lower portion of the water supply unit 6. The container unit 4 includes a lid 14 and a container 24. According to an embodiment of the present invention, the container unit 4 may be configured to facilitate mounting and dismounting by an engagement structure. As shown in FIG. 5D, at a surface where the container unit 4 is mounted, that is, at the lower surface of the frame 16, a seat portion 116, which is a receiving space for accommodating the container unit 4, may be formed, and the seat portion 116 may be provided with a seat portion-protruding rod 66 moveably protruding from the inside of the frame 16. The seat portion-protruding rod 66 may be configured so that it is moveable forward and backward due to its connection to a spring (not shown). Correspondingly, the lid 14 of the container unit 4 is formed with an upper concave portion 314 which is recessed to accommodate the seat portion-protruding rod 66.

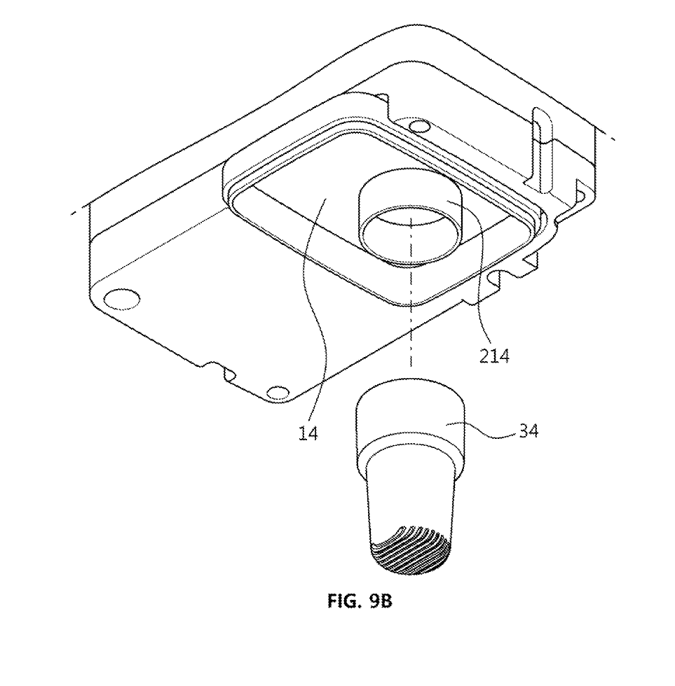

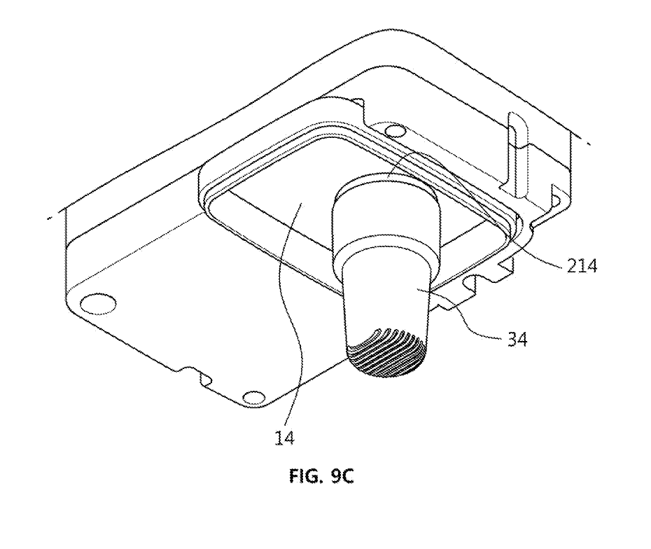

Further, as shown in FIGS. 7, and 9A to 9C, a tea cup mounting portion 214 may be formed in the lower surface of the lid 14. A tea cup 34 may be mounted to tea cup mounting portion 214 so that tea leaves can be brewed.

Referring to FIGS. 7 and 8B, a fitting portion 128 may be formed in the support unit 8 to facilitate mounting of the container unit 4. The lower surface of the container unit 4 may have a shape corresponding to the shape of the fitting portion 128 so that the container unit 4 can be mounted thereto. Further, a lower concave portion 324 may be formed on the lower surface of the container unit 4 to facilitate mounting and dismounting and rigid locking. A mount-protruding rod 1138, including a spring fitted in the lower concave portion 324, is configured to protrude through an opening 1128 formed in the mount 28 so that when the container unit 4 is mounted, the mount-protruding rod 1138 is engaged with the lower concave portion 324. Conversely, and when the container unit is dismounted, the mount-protruding rod 1138 is retracted. The mount-protruding rod 1138 may be integrally formed with the mount 28, or when the mount-protruding rod is assembled to the mount 28, a lower cover 38 may be assembled below the mount 28 to support the mount-protruding rod 1138 and the spring (not shown).

According to the present invention, the automatic water fill dispenser is disposed in the inner side surface of the refrigerator door, so that a large volume of cold water can be conveniently supplied. Further, the water level sensor and the valve are operated by automatic water level detection, thereby increasing user convenience by eliminating any need for a user to observe the water level and manually fill the water. Further, since a detachable structure of the container unit is adopted, it is possible to facilitate mounting and dismounting of the container unit while locking the container unit firmly. Further, a waterproof structure is used when mounting and dismounting the storage unit, e.g., for cleaning, thereby increasing user convenience.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. An automatic water fill dispenser for a refrigerator appliance, the automatic water fill dispenser comprising:
a storage unit disposed in an inner side surface of a refrigerator door and configured to store water therein; and
a container unit disposed on a side of the storage unit and in fluid communication therewith and configured to receive water automatically supplied from the storage unit.

2. The automatic water fill dispenser of claim 1 further comprising a water level sensor coupled on a rear side of the container unit and configured to detect a water level inside the container unit, and
wherein water is automatically supplied to the container unit responsive to a detection by the water level sensor.

3. The automatic water fill dispenser of claim 1 further comprising a water supply unit disposed between the storage unit and the container unit and configured to supply water from the storage unit to the container unit.

4. The automatic water fill dispenser of claim 3, wherein the water supply unit comprises:
a water supply hose configured to be in fluid communication with the storage unit and the container unit; and
a valve configured to regulate a flow of water through the water supply hose.

5. The automatic water fill dispenser of claim 4 further comprising a water level sensor disposed on a rear side of the container unit and configured to detect a water level inside the container unit, and
wherein the valve is configured to be selectively opened and closed responsive to a detection by the water level sensor.

6. The automatic water fill dispenser of claim 1, wherein the container unit is mounted to a receiving unit disposed inside the refrigerator door.

7. The automatic water fill dispenser of claim 6, wherein the container unit comprises a lower concave portion recessed toward a surface side on a lower surface thereof, and
wherein the receiving unit comprises a protruding rod that protrudes from a surface thereof, wherein further the protruding rod is vertically moveable, and engageable with the lower concave portion.

8. An automatic water fill dispenser for a refrigerator appliance, the automatic water fill dispenser comprising:
a storage unit disposed in an inner side surface of a refrigerator door and configured to store water therein;
a container unit disposed on a side of the storage unit and in fluid communication with the storage unit and further configured to receive water automatically supplied from the storage unit; and
a water supply unit disposed between the storage unit and the container unit and configured to supply water from the storage unit to the container unit.

9. The automatic water fill dispenser of claim 8, wherein the storage unit comprises:
a hole disposed in a lower surface of the storage unit;
a sealing member mounted in the hole;
a pin coupled to the sealing member and protruding from the sealing member; and
a spring member mounted to an outer surface of the pin protruding from the sealing member, and
wherein the water supply unit comprises a water receiving portion having an inner space defined by a protruding portion which protrudes from a surface thereof.

10. The automatic water fill dispenser of claim 9, wherein the hole comprises:
a multi-perforated surface; and
a partition member configured to partition the multi-perforated surface.

11. The automatic water fill dispenser of claim 9, wherein the water supply unit comprises:
a lower surface thereof comprising a coupling rod which protrudes therefrom and is further vertically moveable; and
an upper surface thereof comprising an upper concave portion that is recessed toward a surface side to engage with the coupling rod.

12. An automatic water fill dispenser for a refrigerator, the automatic water fill dispenser comprising:
a storage unit disposed on an inner side surface of a refrigerator door and configured to store water therein;
a container unit disposed on a side of the storage unit and in fluid communication with the storage unit and further configured to receive water automatically supplied from the storage unit; and
a water supply unit disposed between the storage unit and the container unit and configured to supply water from the storage unit to the container unit,
wherein the storage unit comprises a hole in a lower surface thereof, and a protruding portion protruding from the lower surface thereof to surround the hole, and
wherein further the water supply unit comprises a coupling portion protruding from an upper surface thereof and engageable with the protruding portion, and a through-hole formed inside the coupling portion.

13. The automatic water fill dispenser of claim 12, further comprising: a water supply hose mounted in the through-hole; and a valve connected to the water supply hose and configured to regulate a flow of water through the water supply hose.

14. The automatic water fill dispenser of claim 13 further comprising a water level sensor disposed on a rear side of the container unit and configured to detect a water level inside the container unit, and
wherein the valve is configured to selectively be opened and closed responsive to a detection by the water level sensor.
